(19) United States
(12) Patent Application Publication
(10) Pub. No.: US 2007/0297952 A1
(43) Pub. Date: Dec. 27, 2007

(54) Apparatus for producing air molecules from water

(76) Inventor: John Henry Hogue, Flint, MI (US)

Correspondence Address: Hogue Family Foundation;Suite A, 5342 Corunna Road, Flint, MI, 48502, US

(21) Appl. No.: 11/247,385

(22) Filed: Jun. 21, 2006

(51) Int. Cl. B01J 10/00

(52) U.S. Cl. 422/129

(57) ABSTRACT

We have looked for clean fresh air for many years now, we have found the solution.

When the inventor's father was on a farm, the farmers would burn weeds and grass left over from the previous years. The air would become polluted. The birds would peck each other, chickens would fight, mules would kick each other, cows would attack each other, and the older children would become irritable. My grandmother would say, “I wish it would rain before every living creature destroys each other.”

It would rain and the birds would sing, every living creature would be happy, because they would be breathing fresh air. It felt like taking a shot of whiskey when you take in a breath of fresh air.

### BACKGROUND OF THE INVENTION

This inversion relates to producing air molecules. We are in great need of more clean air molecules. This application when used will help resolve our problems by keeping a cheap, dependable way of creating air molecules.

### SUMMARY OF THE INVENTION

As shown in the application Ser. No. 11/247,385; one claim was made in the application. This claim uses a home or any kind of water container made from plastic, clay, wood, aluminum, or any material that has small pores that water will go through under pressure, creating air molecules such as trees (help produce air molecules). We are using water pressure such as tap water in a home, business, or a ship out on the ocean, remove the salt from the water and build big tanks to create air 24 hours per day. This will help relieve the problem by having too little air and producing larger quantity of air all over the world.

### BRIEF DESCRIPTION OF THE DRAWINGS

FIG. 1: Is a plastic container.

FIG. 2: Is a plunger.

FIG. 3: Is air molecules.

### DETAILED DESCRIPTION OF THE INVENTION

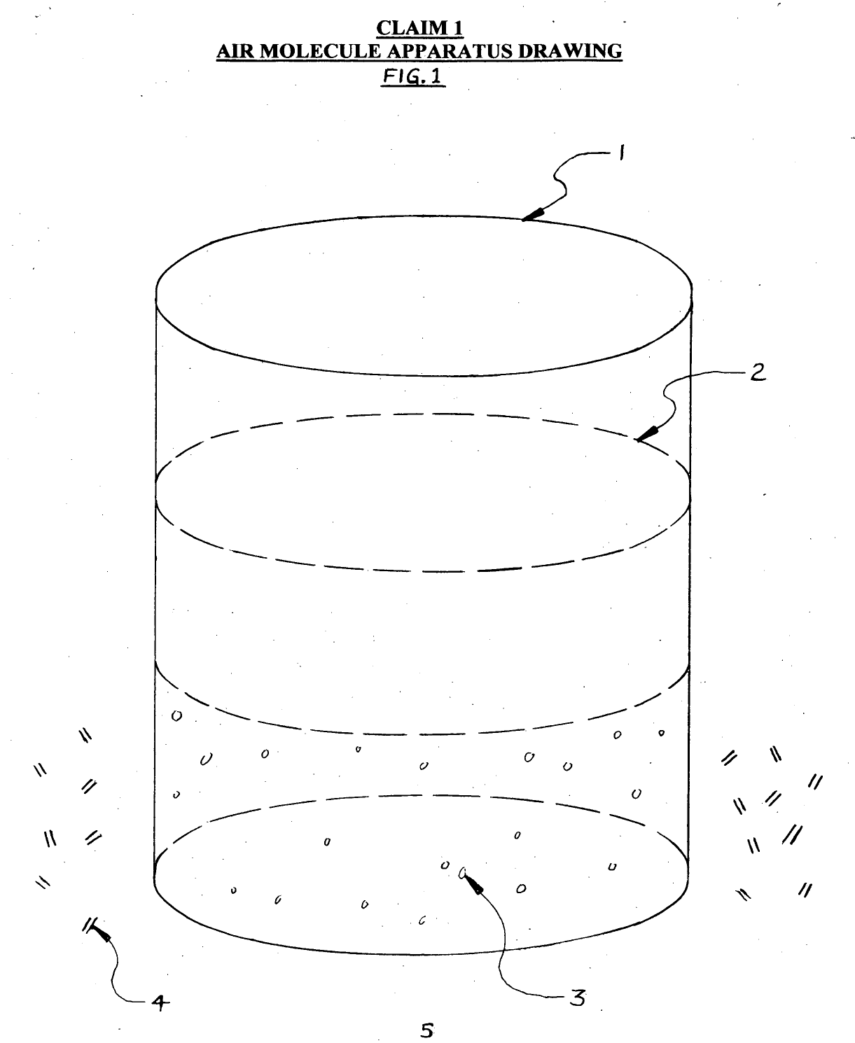

FIG. 1 is a plastic container, non polished on the outside filled with water.

FIG. 2 is a plunger so tightly fitted that the air cannot escape around it. We used a round piece of wood, coated with duct tape.

FIG. 3; when pressure is applied to FIG. 2, water will try to go through FIG. 1. The pores in the plastic will cause the water to turn to air molecules. Fresh air will be created.

I claim:

1) A system to produce air molecules with compressed water.

2) A container made from plastic or any other material that will breathe.

3) A plunger made to fit the container when pressure is applied to it (plunger). Air molecules will form outside of the container.
